(19) United States
(12) Patent Application Publication
(10) Pub. No.: US 2015/0169168 A1
(43) Pub. Date: Jun. 18, 2015

(54) METHODS AND SYSTEMS FOR MANAGING DISPLAYED CONTENT ITEMS ON TOUCH-BASED COMPUTER DEVICES

(71) Applicant: Avincel Group, Inc., Cambridge, MA (US)

(72) Inventors: Aymeric Vigneras, Belmont, MA (US); Etienne Leroy, Arlington, MA (US)

(73) Assignee: Avincel Group, Inc., Cambridge, MA (US)

(21) Appl. No.: 14/569,989

(22) Filed: Dec. 15, 2014

Related U.S. Application Data
(60) Provisional application No. 61/915,610, filed on Dec. 13, 2013.

(51) Int. Cl. G06F 3/0488; G06F 3/0484

(52) U.S. Cl. CPC G06F 3/0488; G06F 3/04842

(57) ABSTRACT

Computer-implemented methods and systems are disclosed for managing content items on a touch-enabled computer device operated by a user. The method includes the steps of: presenting a content item on the display of the computer device; receiving a swipe gesture input on the device from the user; determining a direction and a length of the swipe gesture input; and taking a given action from a set of possible actions on the content item based on the direction and the length of the swipe gesture input.

### CROSS REFERENCE TO RELATED APPLICATION

This application claims priority from U.S. Provisional Patent Application No. 61/915,610 filed on Dec. 13, 2013 entitled METHODS AND SYSTEMS FOR INPUTTING RATINGS ON TOUCH-BASED DEVICES, which is hereby incorporated by reference.

### BACKGROUND

The present application relates generally to touch-based computer devices and, more particularly, to methods and systems for inputting user ratings and otherwise managing displayed content items on such devices.

### BRIEF SUMMARY OF THE DISCLOSURE

In accordance with one or more embodiments, a computer-implemented method is provided for managing content items on a touch-enabled computer device operated by a user. The method includes the steps of presenting a content item on the display of the computer device; receiving a swipe gesture input on the device from the user; determining a direction and a length of the swipe gesture input; and taking a given action from a set of possible actions on the content item based on the direction and the length of the swipe gesture input.

In accordance with one or more embodiments, a touch-enabled computer device is provided for operation by a user. The device includes at least one processor; memory associated with the at least one processor; a display; and a program supported in the memory for managing content items on the touch-enabled computer device. The program contains a plurality of instructions which, when executed by the at least one processor, cause the at least one processor to: present a content item on the display of the computer device; receive a swipe gesture input on the device from the user; determine a direction and a length of the swipe gesture input; and take a given action from a set of possible actions on the content item based on the direction and the length of the swipe gesture input.

In accordance with one or more further embodiments, a computer-implemented method is provided for managing content items on a touch-enabled computer device operated by a user. The method includes the steps of: presenting a content item on the display of the computer device; receiving a down swipe gesture input on the device from the user; and deleting the content item in response to the down swipe gesture input.

### BRIEF DESCRIPTION OF THE DRAWINGS

FIG. 1 is a simplified block diagram illustrating select components of a touch-based computer device in accordance with one or more embodiments.

FIG. 2 is an exemplary screenshot illustrating archiving a displayed content item using a swipe down touch gesture in accordance with one or more embodiments.

FIG. 3 is an exemplary screenshot illustrating deleting a displayed content item using a swipe down touch gesture in accordance with one or more embodiments.

FIGS. 4-6 are exemplary screenshots illustrating rating a displayed item using different swipe up touch gestures in accordance with one or more embodiments.

### DETAILED DESCRIPTION

The present application is directed to methods and systems for inputting user ratings on touch-based computer devices. Such devices can include, without limitation, smart phones (e.g., the Apple iPhone and Android-based smart phones), wearable smart devices (e.g., smart watches), tablet computers (e.g., the Apple iPad tablet), personal computers, smart TVs, game devices, cell phones, and personal digital assistants equipped with a touch interface. The devices include operating systems (e.g., Android, Apple iOS, and Windows Phone OS, among others) on which applications run. The operating systems allow programmers to create applications (often called “Apps”) to provide particular functionality to the devices.

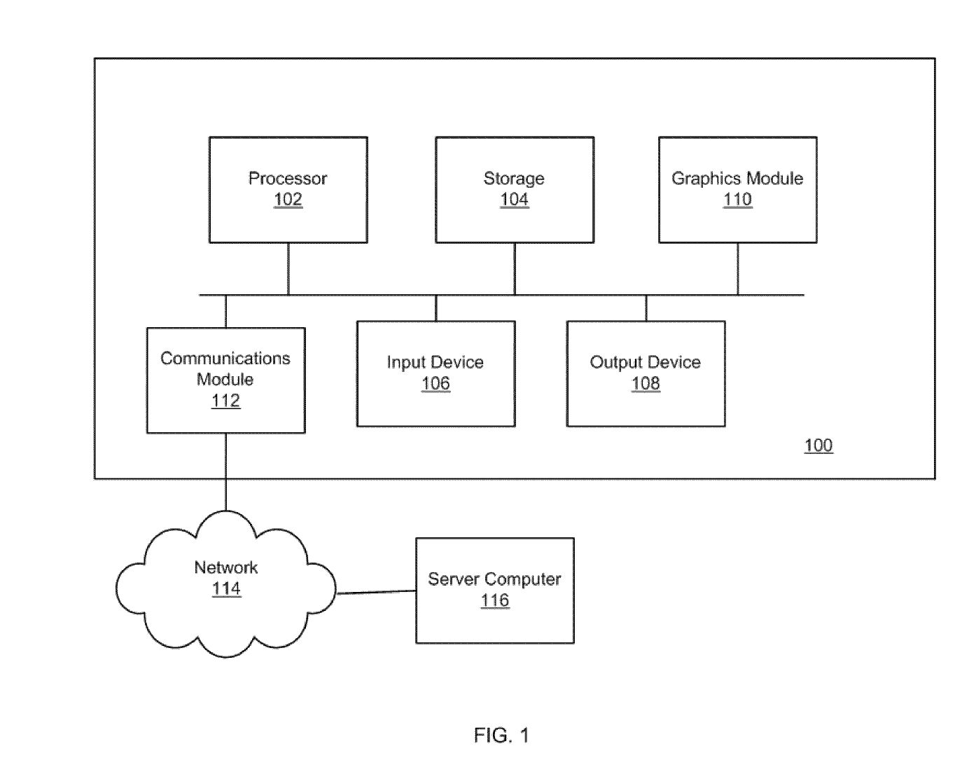

FIG. 1 illustrates a representative user computer device 100 in accordance with one or more embodiments. The device 100 includes at least one computer processor 102, a storage medium 104 readable by the processor 102 for storing applications and data. The device 100 also includes input/output devices 106, 108 such as, e.g., a camera, one or more speakers for acoustic output, a microphone for acoustic input, and a display for visual output, e.g., an LCD or LED display, which has touch screen input capabilities. Alternately, the device may include a trackpad or other touch interface. The device also includes a graphics module for generating graphical objects. The device may also include a communication module or network interface 112 to communicate with a computer server 116 or other devices via telecommunications and other networks 114.

Touch-enabled devices typically allow users to browse displayed content items (e.g., pictures in an album, images, documents, videos, texts, articles, web pages, profiles) using left and right swipe touch gestures.

The present application is directed to methods and systems enabling users to input information and to archive, delete, or hide displayed content items by using up and down swipe gestures, while keeping the capability to browse items through left and right swipe gestures.

In one exemplary embodiment, users can use up swipe gestures to input user ratings for the item displayed on the touch device screen. The higher the user swipes up, the higher the rating applied to the item. The user releases the swipe to validate the rating. A confirmation message may optionally be shown to the user to confirm the rating. Once the user releases the swipe, he or she can be automatically moved to the next item to rate. The user can swipe left and right if he or she does not want to rate the item displayed and to be moved to the next item. Down swipes may be used to move an item to trash, archive, or hide, or to give a negative rating to the item.

The system thereby allows a user to rate or otherwise manage any type of item displayed very quickly and conveniently.

### EXAMPLES

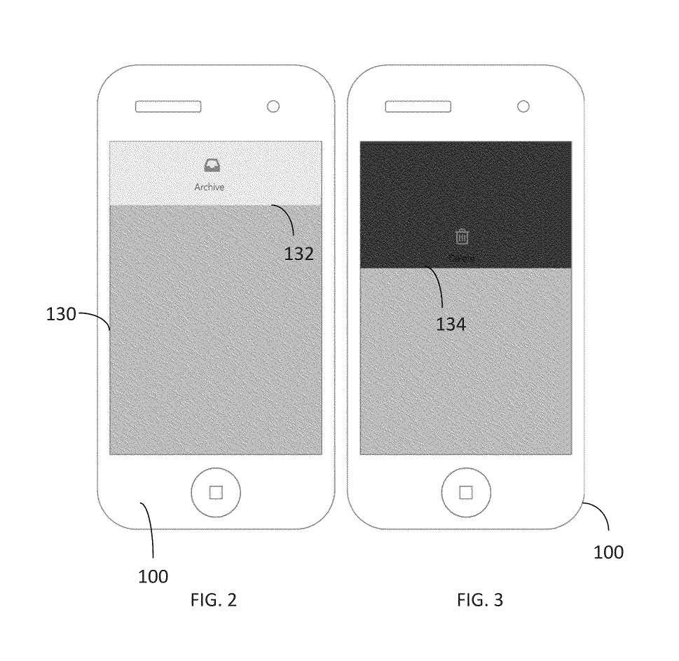

The exemplary screenshot of FIG. 2 illustrates how a user can swipe down to archive the item displayed on the screen 130 of a device 100. In this example, if the user swipes down across a given portion 132 of the screen (e.g., 0% to 25% of the screen) and releases, the item displayed will be archived. The user will also automatically be moved to the next item to be displayed (equivalent to a left swipe).

As shown in the exemplary screenshot of FIG. 3, if the user swipes down across more than a given portion 134 of the screen (e.g., more than 25% of the screen), the item displayed will be deleted. The user may be prompted with a message (e.g., “Are you sure you want to delete this picture?”) to confirm the user's intent to delete. The user can avoid seeing the message again by selecting “Do not display this message again.”

In accordance with one or more embodiments, the user may also hide a content item by swiping down a specified portion of the screen.

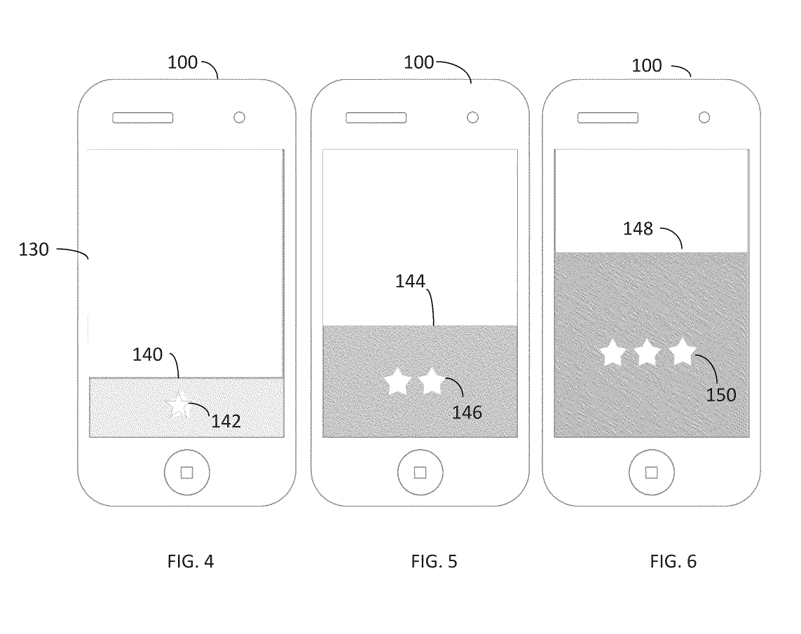

The exemplary screenshots of FIGS. 4-6 illustrate how a user can input a rating with a swipe up gesture.

As shown in FIG. 4, if the user swipes up across a small portion 140 of the screen (e.g., 0% to 25% of the screen) and releases, a low rating 142 (in this example, one star) is added to the item. The user will also automatically be moved to the next item (equivalent to a swipe left) to consider.

As shown in FIG. 5, if the user swipes up across a larger portion 144 of the screen (e.g., 25% to 50% of the screen) and releases, a higher rating 146 (in this example, two stars) is added to the item. The user will also automatically be moved to the next item (equivalent to a swipe left).

As shown in FIG. 6, if the user swipes up across an even larger portion 148 of the screen (e.g., more than 50% of the screen) and releases, an even higher rating 150 (in this example, three stars) is added to the item. The user will also automatically be moved to the next item (equivalent to a swipe left).

In one or more alternate embodiments, the user swiping direction is reversed. For instance, users can apply a downward swipe to input user ratings, and apply an upward swipe to archive, hide, or delete a content item.

The processes of the ratings input and content item management system described above may be implemented in software, hardware, firmware, or any combination thereof. The processes are preferably implemented in one or more computer programs executing on the computer device, which includes one or more computer processors, a storage medium readable by the one or more processors (including, e.g., volatile and non-volatile memory and/or storage elements), and input and output devices. Each computer program can be a set of instructions (program code) in a code module resident in a random access memory of the device. Until required, the set of instructions may be on a remote computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional elements or components or joined together to form fewer elements or components for performing the same functions.

Accordingly, the foregoing description and attached drawings are by way of example only, and are not intended to be limiting.

What is claimed is:

1. A computer-implemented method of managing content items on a touch-enabled computer device operated by a user, the method comprising the steps of:
presenting a content item on the display of the computer device;
receiving a swipe gesture input on the device from the user;
determining a direction and a length of the swipe gesture input; and
taking a given action from a set of possible actions on the content item based on the direction and the length of the swipe gesture input.

2. The method of claim 1, wherein the set of possible actions includes applying a given rating to the content item.

3. The method of claim 2, wherein the score of the given rating is proportional to the length of the swipe gesture input.

4. The method of claim 2, wherein the score comprises one or more stars, and wherein the longer the swipe gesture input, the greater the number of stars in the rating.

5. The method of claim 2, wherein the direction of the swipe gesture input is upward to apply a given rating to the displayed content item.

6. The method of claim 1, wherein the set of possible actions includes archiving, deleting, or hiding the content item.

7. The method of claim 6, wherein a short swipe input gesture results in archiving the content item and a long swipe input gesture results in deleting the content item.

8. The method of claim 6, wherein the swipe input gesture is downward to archive or delete the content item.

9. The method of claim 1, further comprising automatically displaying a next content item after taking said given action.

10. The method of claim 1, wherein the content item comprises, an image, a picture, a document, a video, a text message, an article, or a web page.

11. The method of claim 1, wherein the set of possible actions comprises applying a given rating to the content item when the swipe input gesture is upward, and deleting or archiving the content item when the swipe input gesture is downward.

12. A touch-enabled computer device for operation by a user, comprising:
at least one processor;
memory associated with the at least one processor;
a display; and
a program supported in the memory for managing content items on the touch-enabled computer device, the program containing a plurality of instructions which, when executed by the at least one processor, cause the at least one processor to:
present a content item on the display of the computer device;
receive a swipe gesture input on the device from the user;
determine a direction and a length of the swipe gesture input; and
take a given action from a set of possible actions on the content item based on the direction and the length of the swipe gesture input.

13. The computer device of claim 12, wherein the computer device comprises a smart phone, a wearable smart device, a tablet computer, a personal computer, a smart TV, a game device, a cell phone, or a personal digital assistant.

14. The computer device of claim 12, wherein the computer device includes a touch screen or a touch pad for receiving the swipe input gesture from the user.

15. The computer device of claim 12, wherein the set of possible actions includes applying a given rating to the content item.

16. The computer device of claim 15, wherein the score of the given rating is proportional to the length of the swipe gesture input.

17. The computer device of claim 16, wherein the score comprises one or more stars, and wherein the longer the swipe gesture input, the greater the number of stars in the rating.

18. The computer device of claim 15, wherein the direction of the swipe gesture input is upward to apply a given rating to the displayed content item.

19. The computer device of claim 15, wherein the set of possible actions includes archiving, deleting, or hiding the content item.

20. The computer device of claim 19, wherein a short swipe input gesture results in archiving the content item and a long swipe input gesture results in deleting the content item.

21. The computer device of claim 19, wherein the swipe input gesture is downward to archive, delete, or hide the content item.

22. The computer device of claim 12, further comprising automatically displaying a next content item after taking said given action.

23. The computer device of claim 12, wherein the content item comprises, an image, a picture, a document, a video, a text message, an article, or a web page.

24. The computer device of claim 12, wherein the set of possible actions comprises applying a given rating to the content item when the swipe input gesture is upward, and deleting or archiving the content item when the swipe input gesture is downward.

25. The computer device of claim 12, wherein the computer device comprises a smart phone, a wearable smart device, a tablet computer, a personal computer, a smart TV, a game device, a cell phone, or a personal digital assistant.

26. The computer device of claim 12, wherein the computer device includes a touch screen or a touch pad for receiving the swipe input gesture from the user.

27. A computer-implemented method of managing content items on a touch-enabled computer device operated by a user, the method comprising the steps of:
presenting a content item on the display of the computer device;
receiving a down swipe gesture input on the device from the user; and
deleting the content item in response to the down swipe gesture input.

28. The method of claim 27, further comprising:
presenting another content item on the display of the computer device;
receiving another swipe gesture input on the device from the user;
determining a direction and a length of said another swipe gesture input; and
taking a given action from a set of possible actions on the content item based on the direction and the length of said another swipe gesture input.

29. The method of claim 28, wherein the set of possible actions includes applying a given rating to the content item.

30. The method of claim 29, wherein the score of the given rating is proportional to the length of said another swipe gesture input.

31. The method of claim 29, wherein the score comprises one or more stars, and wherein the longer said another swipe gesture input, the greater the number of stars in the rating.

32. The method of claim 29, wherein the direction of said another swipe gesture input is upward to apply a given rating to the displayed content item.

33. The method of claim 28, wherein the set of possible actions includes archiving, deleting or hiding the content item.

34. The method of claim 33, wherein a short swipe input gesture results in archiving the content item and a long swipe input gesture results in deleting the content item.

35. The method of claim 27, further comprising automatically displaying a next content item after deleting the displayed content item.
